(19) United States
(12) Patent Application Publication
(10) Pub. No.: US 2007/0300041 A1
(43) Pub. Date: Dec. 27, 2007

(54) Method for processing streaming data in a multiprocessor system

(76) Inventor: Wieland Eckert, Furth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/821,065

(22) Filed: Jun. 21, 2007

(30) Foreign Application Priority Data
Jun. 23, 2006 (DE) 10 2006 028 939.0

(51) Int. Cl. G06F 15/00

(52) U.S. Cl. 712/10

(57) ABSTRACT

The present invention relates to a method for processing streaming data in a multiprocessor system. In this method, in a pipelining architecture of the multiprocessor system a specified number of processors having a specified number of programs processes, in a clocked manner, a number of data packets which are inputted at an input point, and makes the processed data available at an output point. The data packets to be processed are distributed between a corresponding number of processors, in which they remain during processing, and the individual programs are then supplied to the individual processors in a timed manner by means of pipelining, such that the individual programs are executed in the corresponding processors on the data packets present there.

### CROSS REFERENCE TO RELATED APPLICATIONS

This application claims priority of German application No. 10 2006 028 939.0 filed Jun. 23, 2006, which is incorporated by reference herein in its entirety.

### FIELD OF THE INVENTION

The present invention relates to a method for processing streaming data in a multiprocessor system. The invention also relates to the use of this method in a medical image processing system.

### BACKGROUND OF THE INVENTION

In a typical x-ray system for interventional angiography a time sequence of x-ray images is generated. The individual images are processed in an unvarying manner, and the speed of processing is subject to certain demands. That is to say, the total latency from acquisition of the image over the entire processing operation to the display on the findings monitor must not exceed a specified time.

Processing of an image involves the use of algorithms for image improvement. These algorithms are implemented in the form of programs representing a transformation of the image information, although the computing power required is very high—in fact so high that it can no longer be made available by an individual commercially available processor. One way of increasing computing power is, for example, to provide special processors such as ASICs or field computers for these algorithms. Special processors of this kind are very expensive, however. One widely used technique is to partition the problem time-wise and location-wise, the object being to divide tasks into smaller sub-tasks which are then computed on a larger number of commercially available universal processors. Precedence is often given to these solutions since, on the one hand, they can be developed more cost-effectively than special hardware and, on the other hand, the use of the individual processors is not restricted to a single processing step—they can also be used for other computing tasks.

One widely used approach is the “pipelining” of processing steps on data which have to be processed in a time sequence. With data pipelining, the newly incoming data are allocated at discrete instants to a processing unit (“processor”) which computes a first portion of an algorithm (“program”). After this calculation has been executed, the interim result is transmitted to a further processing unit which then applies the next step of the algorithm to the data. This is repeated several times until all the steps have been executed and the end result is available. The number of processing steps thus executed is termed the “depth” of the pipeline. This approach is characterized by the fact that one processor and one program are regarded as one (static) pipeline stage and the data are transported onwards.

FIG. 1 shows a typical data pipelining architecture. To keep FIG. 1 simple, no mechanism for controlling the whole pipeline is shown. Such a mechanism carries out the initialization of the processors with programs and controls the transfer of the data from one processor to the next. Of course, the interface with the outside world also has to be controlled here; that is to say, replenishment with new data and the delivery of data on which the calculations are complete. The structure shown in FIG. 1 is also referred to as streaming architecture.

To explain the time sequences of the procedural steps involved in data pipelining as shown in FIG. 1, FIG. 2 provides a table to represent the time sequence for the data pipelining shown in FIG. 1. The example shown in FIG. 2 is restricted to three processors: ALPHA, BETA and GAMMA, which are loaded with three programs A, B, C and work on three data packets Data1, Data2 and Data3. To enable this to be represented simply, a data stream with only three elements is shown, although in reality much longer data streams, ideally of infinite length, are involved. It can be seen from FIG. 2 that the data are transported from one processor to the next, whereas the programs remain on the processor.

Data pipelining as shown in FIGS. 1 and 2 has the following major characteristics:
The number of processors is equal to the number of programs. Since a static allocation of one program to one processor is involved, before every program step a dedicated (optionally virtual) processor must be included in the plan.
All transfers between the processors take place at the same data rate as the input and output connections. The total data rate at a pipeline depth of N is produced from the sum of the input stream, the output stream and the N−1 internal transfers. In total therefore it is N+1 times the input data rate.
The whole system is strictly timed. In one clock pulse one transfer of the input data, one calculation step, and the transfer of the output data are carried out at each stage of the pipeline. The clock pulses of the data transfers and of the calculations are isochronously linked. What that means for the relevant processing steps, that is to say the programs on the processors, in particular is that there has to be strict compliance with the specified clock pulse. None of the programs must take longer than one clock pulse. Nor is there any advantage in one of the programs working more quickly, since the processor would be idle for the remainder of the clock pulse. One difficulty lies in dividing the total computation into individual calculation steps such that, as far as possible, these programs compute for the same length of time in the pipeline.

One simple implementation of the streaming architecture would be to carry out a calculation step and then a data transfer alternately. Optimal utilization of the configuration is achieved only if all the data processors are always in operation and never have to wait for data. Often, however, there are specialized transfer units, such as DMA controllers, which are capable of working at the same time as the data processor. This allows better utilization of the available computing power, although from the programming perspective there has to be a separation of data areas for the current calculation and for the data to be transferred. “Double buffering” (one data area for the current calculation, one data area for transfers) or even “triple buffering” (one data area for calculation, one data area for incoming transfers and one for outgoing transfers) is conventionally used in an attempt to improve this situation. After the calculation there is a changeover to the other data area, although this manifestly reduces the memory available for current data.

Depending on the algorithm, in rare cases it is possible to use a ring buffer and thus manifestly to reduce the cost of double data storage, albeit at the expense of greater administrative complexity.

Thus with all the pipelining methods in the prior art the data are routed. The total volume of data transferred is quite substantially determined by the depth of the pipeline. With data pipelining every data element has to migrate through all the stages of the pipeline. This means that a considerable amount of time is required for the transfers. In other words, a specific bandwidth is required for the transfer from one processing unit to the next. In the case of applications in the field of medical image processing, the programs are typically substantially smaller than the volumes of data on which they are executed.

### SUMMARY OF THE INVENTION

The object of the present invention is to provide a method for processing streaming data in a multiprocessor system which runs more quickly, as a result of which the method can be implemented more easily, and costly restructuring of the programs can be avoided when they are adapted to smaller workloads.

This object is achieved according to the claim. Features of preferred embodiments of the present invention are characterized in the subclaims.

The present invention can be used in medical image processing systems in particular.

As already mentioned, in medical data processing the individual programs are considerably smaller than one data set, typically by factors of between 10 and 1000. This also impacts on memory mapping in the case of double buffering. While the memory is divided into two large areas for data and one small area for the program in data pipelining, in program pipelining the same available memory is used in two small areas for programs and one very large area for data.

Program pipelining involves the routing of complete programs which are originally “read only” and thus cannot be modified. They can therefore be transferred at any instant; it must just be ensured that the transfer is complete when this program is required by the processor. By comparison with data pipelining it is substantially easier to convert the same algorithm into a program, and the procedure is less prone to error.

Furthermore, according to the invention the number of programs can be greater than the number of processors. Thus, while retaining the programs the number of processors required for processing can be reduced if faster processors are available, and so costs can be cut.

Different topologies, for example a ring topology or a star topology, are suitable for the administration of the programs.

Above all, the use of a star topology makes it possible to dispense with one previous requirement whereby all the programs have to have the same runtime, or rather the performance of the processors is governed by the runtime of the slowest program in the data pipeline. This is no longer a requirement according to the invention, since a processor is made independent of the program pipeline timing; that is to say, the processor can, for example, first execute a program A which lasts considerably longer than the program progression timing, and can then execute a program B which runs much more quickly. The only remaining restriction is that the whole string of programs has to be executed during the time available, that is to say, the sum of the individual runtimes is smaller than the latency.

### BRIEF DESCRIPTION OF THE DRAWINGS

In the following the invention is explained in more detail by means of the description of an exemplary embodiment with reference to the drawing, in which

FIG. 1 shows: a typical data pipelining architecture;

FIG. 2 shows: an exemplary time sequence for data pipelining;

FIG. 3 shows: an architecture for implementation of the program pipelining according to the invention;

FIG. 4 shows: an exemplary time sequence for program pipelining; and

FIG. 5 shows: the separation of the program progression timing from the I/O timing in the program pipelining according to the invention.

### DETAILED DESCRIPTION OF THE INVENTION

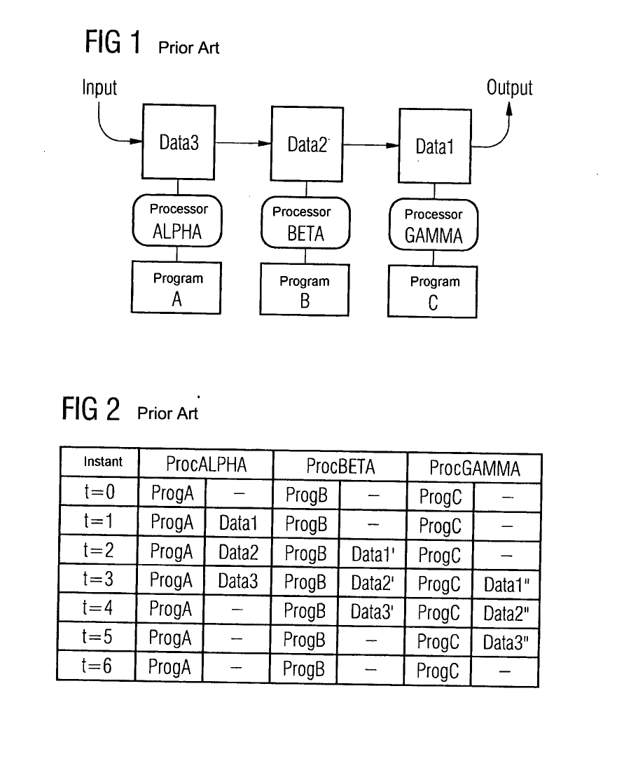

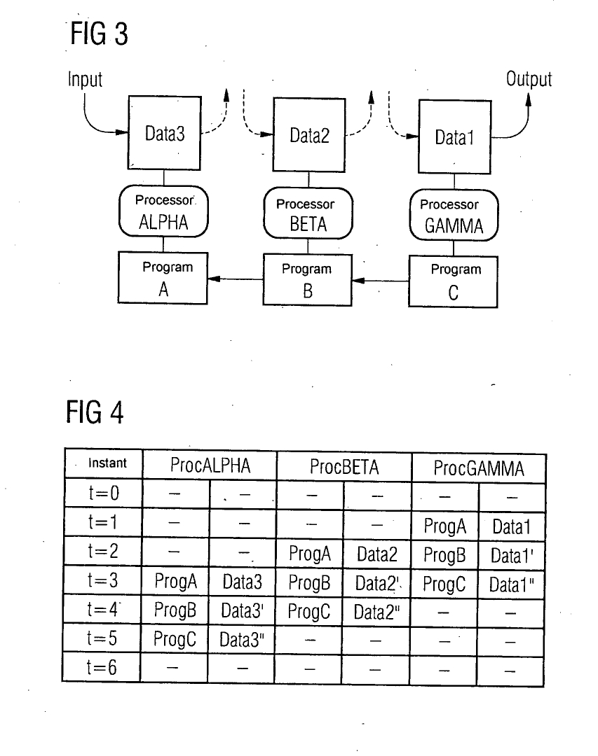

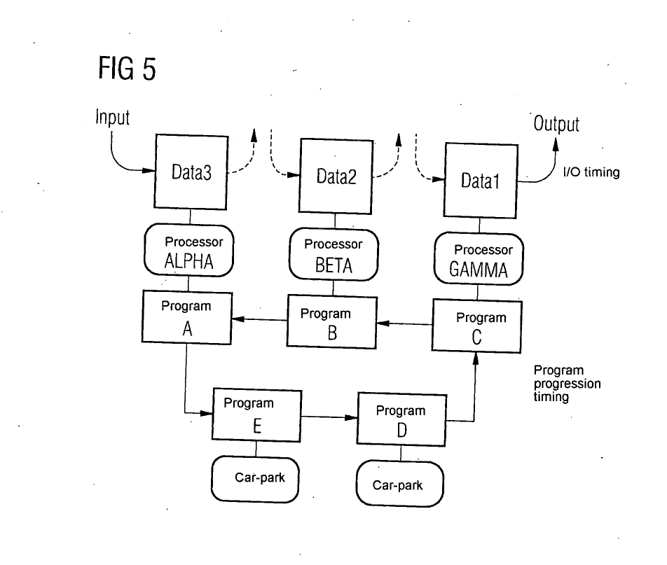

In the following, the approach of program pipelining is described with reference to FIGS. 3 to 5 and contrasted with the data pipelining explained above with reference to FIGS. 1 and 2. Formally, one processing step is described by one tuple (program, processor, data) which defines the assignment of a sub-problem at a specific instant. In the data pipelining already described above, the processor and program form one processing stage. This stage is constructed once and is then never modified: only the data are replaced. In program pipelining on the other hand, a processor is loaded with a data set which, as shown in FIG. 3, then also remains on this processor. The individual programs are then routed to this processor in a time sequence, and the processor executes the programs on the data present (FIG. 4). The exchange of the programs in the correct sequence ultimately leads to the same calculation being carried out as in data pipelining.

Once the calculation has been completed, the data are likewise supplied to the consumer (output) and the memory now free is loaded with newly incoming data. The control mechanism required has similar tasks to those in data pipelining, although the program is now regarded by the tuple (program, processor, data) as migrating from one processor to the next. This takes place counter to the direction of data flow. FIG. 4 shows the sequence for the program pipelining according to the invention, this sequence corresponding to FIG. 2.

The method can be implemented in various forms. In one implementation, processing can take place by means of commercially available multiprocessor systems which are ideally also provided with multicore processors (current and new PC architectures from INTEL, AMD, etc.). However, this method can also be implemented on cluster computers (BladeCenter). Equally, implementation is also possible on multi-DSP configurations. Not least, new processor architectures are likewise very suitable for the implementation of this method, for example Cell processors from IBM/Sony/Toshiba.

Almost all implementations suitable for data pipelining are also candidates for the implementation of program pipelining.

In the exemplary embodiment described it is assumed that the programs are passed on from one processor to the other, with the sequential control system specifying the direction and the timing; this is shown in FIG. 3 and represents the preferred implementation in the form of a ring. It is also possible to use a star topology so that programs are supplied from a central point. Here a distinction is made between, on the one hand, implementation with centralized command control through the sequential control system (push method) and, on the other hand, decentralized control in the processors themselves, which fetch the relevant program independently from a common library (pull method). With the pull method, the entire sequence can in turn be predefined (worklist), and the processor then repeatedly executes this worklist on new data; or the sequential control system informs the processor only of the next step to be carried out in each case (workstep).

Different implementations are possible for the higher level control entity. The form shown in FIG. 3 is based on direct communication between the processing stages. Here ring topology would present itself as a preferred form of implementation. The selection of the topology doubtless depends on the features of the hardware available. The control entity can be implemented in dedicated hardware (ASIC), in programmable hardware (FPGA), in software, or by a combination of these technologies.

Irrespective of the topology selected, however, both data pipelining and program pipelining require an element (not shown in the figures) responsible for sequential control and the transfers. Often this might be implemented as a kind of dedicated control and monitoring processor (or logic module) responsible for initialization, loading of the programs, organization of the input and output data paths and also progression to the next clock pulse. Nevertheless, this task can also be carried out by one of the computer units described above, which can perform this in addition to the calculation proper.

The new possibility of selecting the program timing independently of the data timing provides substantially new degrees of freedom for the design of the individual programs. In the previous isochronous pipelining, the execution time for an individual program was defined by the dominant timing of the data transfers. In program pipelining the program can now be progressed with a timing different from the input and output timing. One possibility for using the different timings is shown in FIG. 5, subject only to adherence to the overall cycle time (latency).

In this case the ratio between the I/O timing and the program progression timing will therefore be a fraction of natural numbers (in the example shown in FIG. 5, 3:5); on the other hand, with isochronism in the case of data pipelining a ratio of N:N is always required. FIG. 5 shows a ring program topology, although the same considerations naturally also apply to a star topology.

The feature undoubtedly of greatest importance for use in a medical image processing system is the reduction in the transfer bandwidth required, as already mentioned above, and hence the simplification of the hardware implementation by comparison with data pipelining. The elimination of the previous isochronous linking of the I/O timing and the program progression timing reduces the complexity of the programs and allows a, previously impossible, variation in the granularity of the algorithms; this is reflected in a shorter development time. Lastly, program pipelining is also easier to scale, particularly in relation to an increase (or even a decrease) in the data throughput. When a system is designed with data pipelining, the number of processors required is always definitively based on the maximum throughput. However, with program pipelining a small workload can also mean a smaller number of processors. Thus, for example, an x-ray system which is designed for 30 images per second with 1.024×1.024 pixels can be set up much more cost-effectively than a variant for 60 images per second with 2.048×2.048 pixels; furthermore, there is no need to modify the architecture of the image chain for this purpose, as would be the case with data pipelining.

The above description of an exemplary embodiment of the present invention is intended merely for illustrative purposes and is in no way to be construed as limiting. On the contrary, the present invention encompasses all conceivable variants covered by the attached claims.

1.-9. (canceled)

10. A method for processing streaming data in a multiprocessor system having a pipelining architecture, comprising:
inputting a plurality of data packets at an input time;
distributing the data packets between a plurality of processors where the data packets remain during the processing;
timely supplying programs to the processors by pipelining;
executing the programs on the data packets presented in the processors; and
outputting the processed data packets at an output time.

11. The method as claimed in claim 10, wherein the execution is performed by a system selected from the group consisting of: multicore data processors, cluster computers, multi-DSP configurations, and Cell processors.

12. The method as claimed in claim 10, wherein the programs are pipeliningly supplied to the processors with a sequential control system.

13. The method as claimed in claim 12, wherein the sequential control system has a ring topology.

14. The method as claimed in claim 12, wherein the sequential control system has a star topology.

15. The method as claimed in claim 14, wherein the star topology comprises a centralized command control through the sequential control system.

16. The method as claimed in claim 14, wherein the star topology comprises a decentralized command control in the processors by which the programs are fetched from a common library.

17. The method as claimed in claim 10, wherein the input and output of the data packets and the pipelining for the programs are controlled by a higher level control entity.

18. The method as claimed in claim 17, wherein the higher level control entity is implemented in a system selected from the group consisting of: a dedicated hardware, a programmable hardware, a software, and a combination thereof.

19. The method as claimed in claim 10, wherein a number of the programs can be different from a number of the processors in the pipeline architecture.

20. The method as claimed in claim 10, wherein the programs are progressed in the pipelining with a time difference from the input-output time subject to adherence to an overall cycle time.

21. The method as claimed in claim 20, wherein running times of the programs can be different and a sum of the runtimes of the programs is smaller than the overall cycle time.

22. A medical image processing system for processing a plurality of medical images, comprising:
a plurality of processors comprising a plurality of programs that timely process the medical images, the medical images being distributed between the processors and remained on the processors during the processing; and
a computer that timely supplies the programs to the processors by pipelining and executes the programs on the medical images presented in the processors.

23. An x-ray system for recording a plurality of medical images of a patient, comprising:
an x-ray source that emits x-rays to the patient;
an x-ray detector that records the medical images of the patient by detecting the x-rays penetrating the patient; and
an image processing system comprising:
a plurality of processors comprising a plurality of programs that timely process the medical images, the medical images being distributed between the processors and remained on the processors during the processing, and
a computer that timely supplies the programs to the processors by pipelining and executes the programs on the medical images presented in the processors.

24. The x-ray system as claimed in claim 23, wherein the programs are pipeliningly supplied to the processors with a sequential control system.

25. The x-ray system as claimed in claim 23, wherein a number of the programs can be different from a number of the processors.

26. The x-ray system as claimed in claim 23, wherein the programs are progressed in the pipelining with a time difference from an input-output time of the medical images subject to adherence to an overall cycle time.

27. The x-ray system as claimed in claim 26, wherein running times of the programs can be different and a sum of the runtimes of the programs is smaller than the overall cycle time.
